(19) United States
(12) Patent Application Publication
(10) Pub. No.: US 2005/0001909 A1
(43) Pub. Date: Jan. 6, 2005

(54) Image taking apparatus and method of adding an annotation to an image

(75) Inventors: Noriyuki Okisu, Osakasayama-shi (JP); Rieko Izume, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 10/877,034

(22) Filed: Jun. 25, 2004

(30) Foreign Application Priority Data
Jul. 2, 2003 (JP) 2003-190545

(51) Int. Cl. H04N 5/262

(52) U.S. Cl. 348/231.5

(57) ABSTRACT

An image taking apparatus can add an annotation to a partial region within an image without any restrictions on the number and types of annotations so added. The association between an image and an annotation is recorded in a file separate from the image file and the annotation file. When the image file or the annotation file is deleted, when electric power has just started to be supplied, when an operation mode for adding an annotation is established for the first time, when a recording medium is mounted, and when an external device is disconnected, the contents of the file having the association recorded therein are updated so as to be kept always correct.

This application is based on Japanese Patent Application No. 2003-190545 filed on Jul. 2, 2003, the contents of which are hereby incorporated by reference.

### BACKGROUND OF THE INVENTION

1. Field of the Invention

The present invention relates to an image taking apparatus that can add an annotation to a partial region within a photographed image, and to a method of achieving that.

2. Description of the Prior Art

It has been proposed to add an annotation to the whole of or a partial region within an image photographed with a digital camera. This helps enhance the image's ability to convey information. When an annotation is added to the whole of an image, it is necessary to make clear the association between the image and the annotation; when an annotation is added to a partial region within an image, it is necessary to make clear the association between the image, that particular partial region thereof, and the annotation.

U.S. Pat. No. 5,982,981 discloses a technique of recording the association between an image and a sound in the tag (header) of each of the image file in which the image date is recorded and the sound file in which the sound data is recorded. This technique of recording information indicating the association between different contents in the tag of files is easy to practice, and is very useful in cases where images correspond to annotations on a one-to-one basis.

However, in general, the tag of a file has a fixed length, and thus the amount of information that can be recorded therein is limited. Accordingly, when an annotation is added to a partial region within an image, it is not always appropriate to record association information in the tag of a file. The reason is that, when an annotation is added to a partial region within an image, as is often the case, a plurality of regions are set within a single image so that a plurality of annotations are added thereto, with the result that the total amount of information indicating the association between the image, the regions set within it, and the corresponding annotations is too large to be completely recorded in the tag. Thus, sticking to the method of recording information indicating the association between an image and an annotation in the tag of a file results in placing restrictions on the number and types of annotations that can be added to a single image.

### SUMMARY OF THE INVENTION

An object of the present invention is to provide an image taking apparatus that can add an annotation to a partial region within an image without any restrictions on the number and types of annotations so added, and to provide a method of achieving that.

To achieve the above object, according to one aspect of the present invention, an image taking apparatus is provided with: an image generator for generating an image; an annotation generator for generating an annotation that is to be added to a partial region within the image generated by the image generator; a file generator for generating an association file in which the association between the image generated by the image generator and the annotation generated by the annotation generator is recorded; and a recorder for recording the association file generated by the file generator on a recording medium.

In this image taking apparatus, the association between an image and an annotation is recorded not in the tag of a file but in a file of its own, i.e., as the contents of an independent file (in the main portion thereof as the region for recording information, i.e., elsewhere than in the tag). Accordingly, even when many annotations are added to a single image and thus the amount of association information is large, all the information can be recorded. Moreover, it is possible to record many kinds of information indicating the association between an image and an annotation.

In the image taking apparatus described above, advisably, when at least either the image having the annotation added thereto or the annotation is deleted, the association file is updated. By so doing, when an image or an annotation is deleted, it is possible to delete unnecessary and misguiding association information from an association file and thereby to keep the contents of the association file correct.

In the image taking apparatus described above, advisably, when a mode for adding an annotation is established for the first time after the starting of the supply of electric power, the association file is updated. By so doing, even in cases where a recording medium is dismounted while no electric power is being supplied and an image or an annotation is deleted on another apparatus, it is possible to keep the contents of an association file correct.

In the image taking apparatus described above, advisably, when the recording medium is mounted, the association file is updated. By so doing, even when a recording medium from which an image or an annotation has been deleted is mounted while electric power is being supplied, i.e., while the image taking apparatus is operating, it is possible to keep the contents of an association file correct.

In the image taking apparatus described above, advisably, when an external device is disconnected, the association file is updated. By so doing, even when images or annotations are read out by an external device connected, then all or part of them are deleted, and then new ones are recorded in place of the deleted ones, it is possible to keep the contents of an association file correct.

In the image taking apparatus described above, advisably, the image to which the annotation is added, the annotation itself, and the association file in which the association between the image and the annotation is recorded are recorded, in a form stored in a single folder, on the recording medium. This makes management easy.

According to another aspect of the present invention, a method of adding an annotation to a partial region within an image includes the steps of: generating an annotation; generating an association file in which the association between the image and the annotation is recorded; and recording the generated association file on a recording medium. By recording the association between an image and an annotation in a file of its own, i.e., as the contents of an independent file, it is possible, even in cases where many annotations are added to a single image and thus the amount of association information is large, to record all the information. Moreover, it is possible to record many kinds of information indicating the association between an image and an annotation.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a perspective view of a digital camera as one embodiment of the invention;

FIG. 2 is a rear view of the digital camera;

FIG. 3A is a diagram showing an example of a parent image to which an annotation is added by the digital camera;

FIG. 3B is a diagram showing an example of an annotation image added to the parent image by the digital camera;

FIG. 4 is a diagram showing the structure of file folders in the digital camera;

FIG. 5 is a diagram schematically showing the circuit configuration of the digital camera;

FIG. 6 is a flow chart showing the flow of operations performed to set a photographing mode when electric power starts to be supplied to the digital camera;

FIG. 7 is a diagram showing the main menu that the digital camera displays to permit the selection of a photographing mode;

FIG. 8 is a flow chart showing the flow of operations performed to change photographing modes in the digital camera;

FIG. 9 is a flow chart showing the flow of operations performed in the image annotation photographing mode in the digital camera;

FIG. 10 is a diagram showing an example of the screen that the digital camera displays to permit the selection of a parent image to which to add an annotation;

FIG. 11 is a flow chart showing the flow of operations performed to select a parent image in the digital camera;

FIG. 12 is a diagram showing an example of the warning that the digital camera displays when an inappropriate image is selected as a parent image;

FIG. 13 is a diagram showing an example of the initial screen that the digital camera displays to permit the setting of a region in a parent image;

FIG. 14 is a diagram showing an example of a screen including a moved region in the digital camera;

FIG. 15 is a diagram showing an example of a screen including a moved and resized region in the digital camera;

FIG. 16 is a diagram showing an example of a screen that the digital camera displays to permit the setting of a region in an image to which an annotation has already been added;

FIG. 17 is a flow chart showing the flow of operations performed to set a region in a parent image in the digital camera;

FIG. 18 is a flow chart showing the flow of operations performed in the sound annotation photographing mode in the digital camera;

FIG. 19 is a flow chart showing the flow of operations performed when the photographing of an annotation image or the recording of an annotation sound is ended;

FIG. 20 is a flow chart showing the flow of operations performed when the image annotation photographing mode or the sound annotation photographing mode is established for the first time after the start of the supply of electric power to the digital camera;

FIG. 21 is a flow chart showing the flow of operations performed when a recording medium is mounted while electric power is being supplied to the digital camera;

FIG. 22 is a flow chart showing the flow of operations performed when an external device is disconnected while electric power is being supplied to the digital camera;

FIG. 23 is a flow chart showing the flow of operations performed to provide a quick view in the digital camera;

FIG. 24 is a flow chart showing the flow of operations performed when a file is deleted during a quick view;

FIG. 25 is a flow chart showing another flow of operations performed to start a quick view in a state in which a screen for the setting of a region is displayed in the digital camera;

FIG. 26 is a diagram showing another main menu that the digital camera displays to permit the selection of a photographing mode;

FIG. 27 is a flow chart showing the flow of operations performed in the annotation photographing mode in the digital camera;

FIG. 28 is a diagram showing the screen that the digital camera displays to permit the selection of whether to use as a parent image one that is going to be photographed or one that already exists;

FIG. 29 is a diagram showing the screen that the digital camera displays to permit the selection of whether to use an image or a sound as an annotation to be added to a parent image;

FIG. 30 is a flow chart showing the flow of operations relating to the setting of a photographing mode at the start of the supply of electric power to the digital camera;

FIG. 31 is a flow chart showing the flow of operations performed to change photographing modes in the digital camera; and

FIG. 32 is a diagram showing an example of the screen that the digital camera displays to permit the selection of whether to use as a parent image one that is going to be photographed or one that already exists and the selection of which existing image to use as a parent image.

### DESCRIPTION OF THE PREFERRED EMBODIMENTS

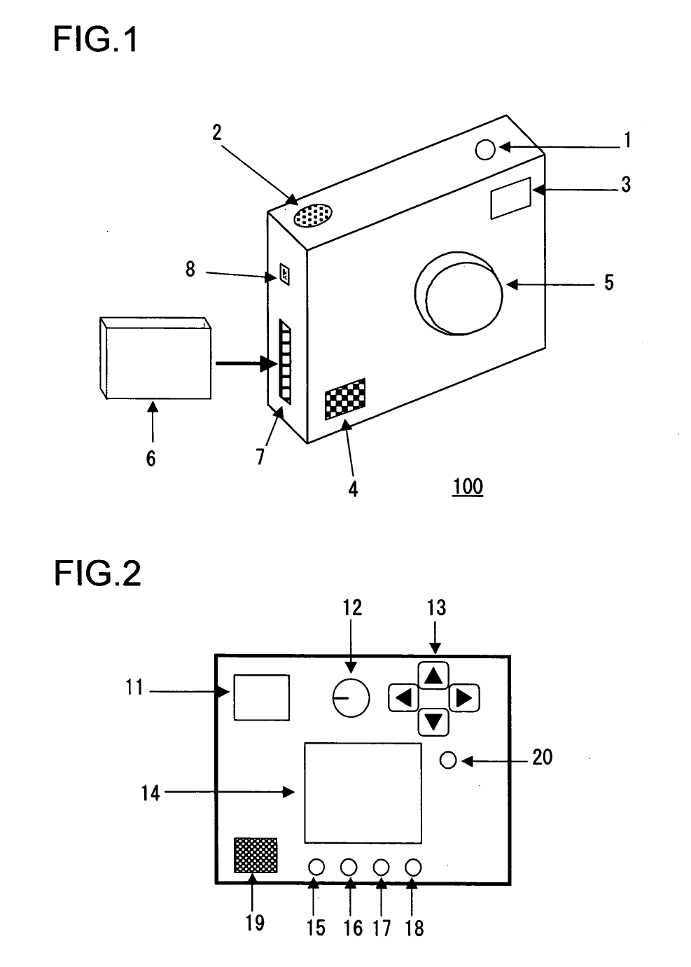

Hereinafter, a digital camera as one embodiment of the present invention will be described with reference to the accompanying drawings. The exterior appearance of the digital camera 100 of this embodiment is shown in FIG. 1, which is a perspective view thereof, and FIG. 2, which is a rear view thereof. The digital camera 100 is provided with: on the top face, a power button 1 and a shutter button 2; on the front face, a viewfinder front window 3, a microphone 4, and a taking lens 5; on a side face, a slot 7, though which a recording medium 6 is mounted, and an external device connection terminal 8; and, on the rear face, a viewfinder rear window 11, a mode select dial 12, four direction keys 13, a liquid crystal display 14, five operation buttons 15, 16, 17, 18, and 20, and a loudspeaker 19.

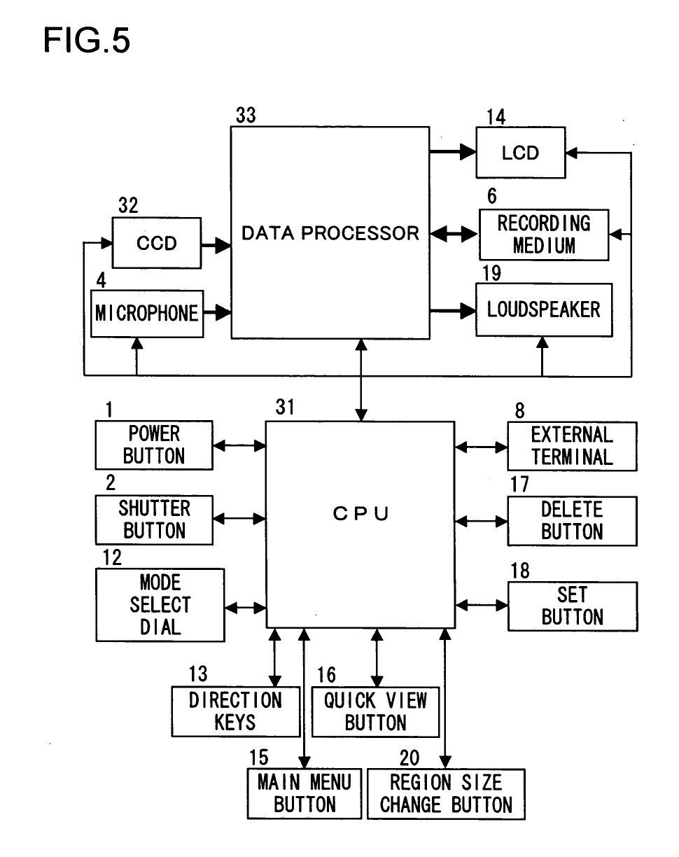

The digital camera 100 incorporates a CCD area sensor 32 (see FIG. 5), and photographs an image by imaging the light from a subject through the taking lens 5 on the sensor 32. The photographed image is recorded on the recording medium 6, and is displayed on the display 14. An image recorded on the recording medium 6 can also be reproduced and displayed on the display 14.

The digital camera 100 has a capability of adding an annotation to a region within an image. In the following description, this capability will be referred to as the annotation capability, and the operation mode in which the annotation capability is executed will be referred to as the annotation mode. An annotation can be added in one of two forms, namely either in the form of an image or in the form of a sound. An image used as an annotation will be referred to as an annotation image, and a sound used as an annotation will be referred to as an annotation sound. An image to which an annotation is going to be added or has already been added will be referred to also as a parent image.

The microphone 4 is used to record an annotation sound, and the loudspeaker 19 is used to reproduce an annotation sound. The operation buttons 15 to 18 and 20 are operated to select an image, to specify a partial region within an image, and for other purposes in the annotation mode. The operations buttons 15, 16, 17, 18, and 20 will be referred to as the main menu button, quick view button, delete button, set button, and region size change button, respectively.

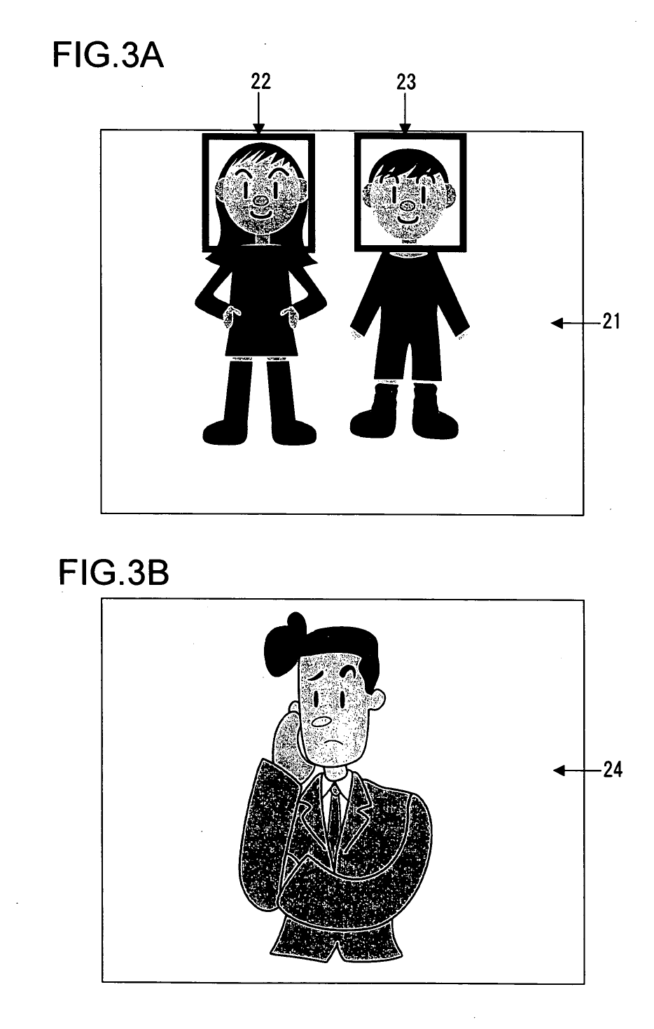

Now, the annotation capability of the digital camera 100 will be described with reference to FIGS. 3A and 3B. FIG. 3A shows an example of a parent image to which an annotation is added. An annotation is added to a partial region (or to each of a plurality of partial regions) within this parent image 21. In this particular image 21, two regions have been set, and region frames 22 and 23 are displayed to indicate those regions respectively. These regions each have an annotation added thereto. It should be noted that the region frames 22 and 23 are added when the image 21 is displayed on the liquid crystal display 14, and therefore that the image 21 itself does not include any image corresponding to the region frames 22 and 23.

FIG. 3B shows an example of an annotation image added to the parent image 21. This image 24 is a photograph of the father of the girl appearing in the region frame 22. To the region frame 23 is added, for example, an annotation sound that says “This boy is John.”

The file of the annotation image 24 and the file of the above-mentioned annotation sound are associated with the file of the image 21, and this association is recorded in a predetermined file. This file will be referred to as the association file. All these files can be transferred to a personal computer so that they are browsed thereon. This contributes to deeper understanding of the parent image 21 and better communication.

The contents of the association file are shown in Table 1.

TABLE 1
Association File

| Item | Content |
|---|---|
| 1 | Parent image file name |
| 2 | Parent image file creation date and time |
| 3 | Annotation region position information |
| | (the coordinates of the upper left-hand corner) |
| 4 | Annotation region size information |
| | (the vertical and horizontal widths) |
| 5 | Annotation file name |
| 6 | Annotation file creation date and time |

It should be noted that, for items Nos. 3 to 6, there exist as many sets of them as the number of annotations added to the parent image. The association file is updated whenever the association information needs to be changed, as when a new annotation is added and when a file is deleted.

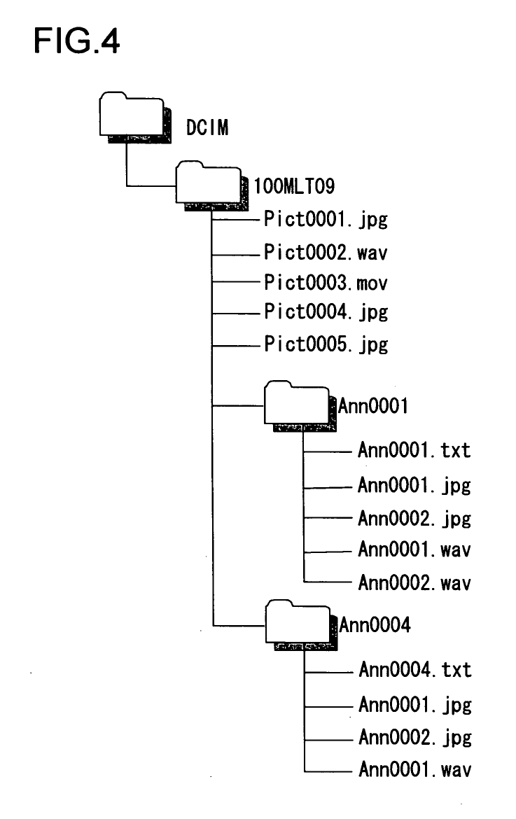

FIG. 4 shows the structure of file folders in the digital camera 100. In this example, there are files named “Pict0001.jpg” and “Pict0004.jpg,” which are parent image files. These files are stored in a DCF (Design Rule for Camera File System) folder named “100MLT09,” in which there exist annotation folders named “Ann0001” and “Ann0004.” The numbers “0001” and “0004” in the annotation folder names are the same as those in the parent image file names “Pict0001.jpg” and “Pict0004.jpg,” and this achieves the association between the parent images and the annotation folders.

In each annotation folder, there are stored an association file, an annotation image file, and an annotation sound file. For example, in the folder “Ann0001,” there are stored an association file named “Ann0001.txt”, two annotation image files named “Ann0001.jpg” and “Ann0002.jpg,” and two annotation sound files named “Ann0001.wav” and “Ann002.wav.”

With respect to the photographing of still images, the digital camera 100 has the following four modes: a normal photographing mode, a document photographing mode, an image annotation photographing mode, and a sound annotation photographing mode. The normal photographing mode is used to perform photographing as performed by a common digital camera. The document photographing mode is used for the photographing a character-based subject such as a document or a white board. The image annotation photographing mode is used to add an annotation image to a parent image. The sound annotation photographing mode is used to add an annotation sound to a parent image. The annotation mode mentioned earlier includes the image annotation photographing mode and the sound annotation photographing mode.

The information on the photographing mode of a photographed image or a recorded sound is recorded in the tag (header) of a file. The photographing mode information is referred to, when an image is reproduced and displayed or a sound is reproduced, to indicate in what mode the image or sound was photographed or recorded. The photographing mode information is recorded in a one-byte region within the tag. Table 2 shows each bit in that region and what it means when it is set to “1.”

TABLE 2
Photographing Mode Information

| Bit | Meaning |
|---|---|
| 0 | Image photographed in the normal photographing mode |
| 1 | Image photographed in the document photographing mode |
| 2 | Parent image in the image annotation photographing mode |
| 3 | Annotation image photographed in the image annotation |
| | photographing mode |
| 4 | Parent image in the sound annotation photographing mode |
| 5 | Annotation sound recorded in the sound annotation |
| | photographing mode |
| 6 | Moving picture |
| 7 | Sound other than an annotation sound |

Each bit is updated whenever it needs to be changed, as when an image is photographed and when an annotation is added. More than one bit may be set to “1” simultaneously. For example, when an image photographed in the normal photographing mode is used as a parent image in the sound annotation photographing mode, bits 0 and 4 are both set to “1.”

The circuit configuration of the digital camera 100 is schematically shown in FIG. 5. The output signal of the sensor 32 is converted into image data representing an image by a data processor 33, and is displayed on the liquid crystal display 14 and, in response to a command to do so, recorded on the recording medium 6. The output signal of the microphone 4 is converted into digital sound data by the data processor 33, and is recorded on the recording medium 6. An image recorded on the recording medium 6 can, through the data processor 33, be displayed on the liquid crystal display 14, and a sound recorded on the recording medium 6 can, through the data processor 33, be reproduced from the loudspeaker 19. All these operations are controlled by a CPU 31.

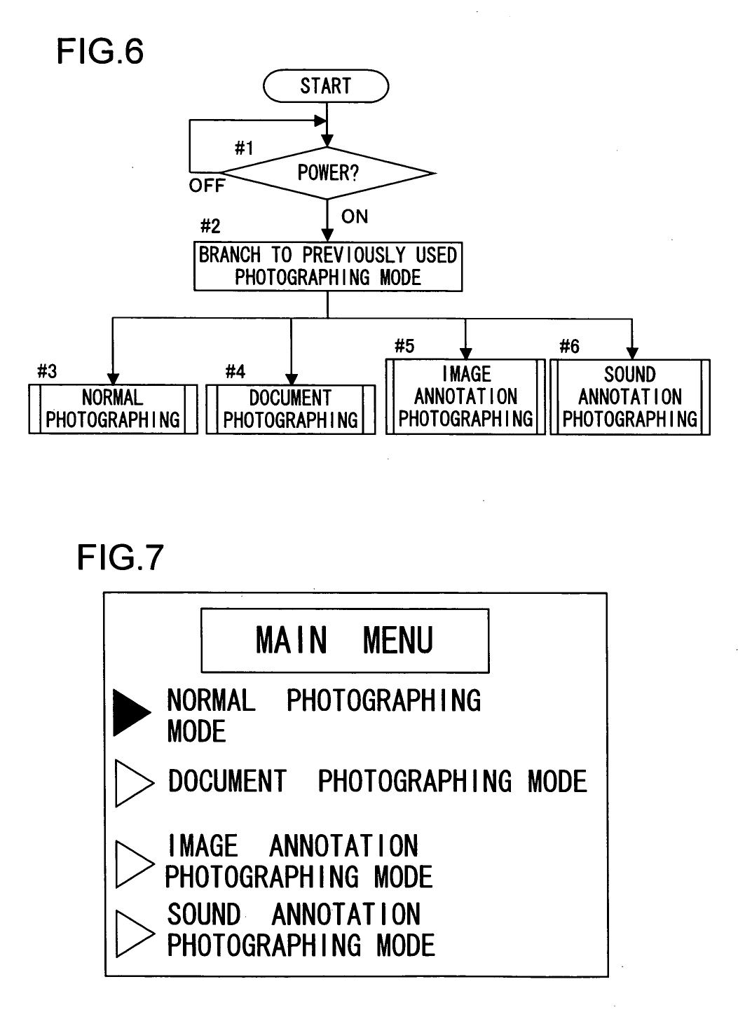

FIG. 6 shows the flow of operations relating to the setting of a photographing mode at the start of the supply of electric power. When the supply of electric power to the digital camera 100 is stopped, it stores the photographing mode at that moment so that, when the supply of electric power to the digital camera 100 is started (step #1), it establishes the stored photographing mode (steps #2 to #6).

On the liquid crystal display 14 are displayed not only images but also various menu screens for guiding the user through operations such as the switching of photographing modes. FIG. 7 shows the main menu displayed on the liquid crystal display 14. The main menu permits the selection of one of the four photographing modes described earlier. In the example shown in FIG. 7, the normal photographing mode is selected. One of the modes is selected by operating the four direction keys 13, and the selected one is confirmed by operating the set button 18. The main menu itself can be called up by operating the main menu button 15.

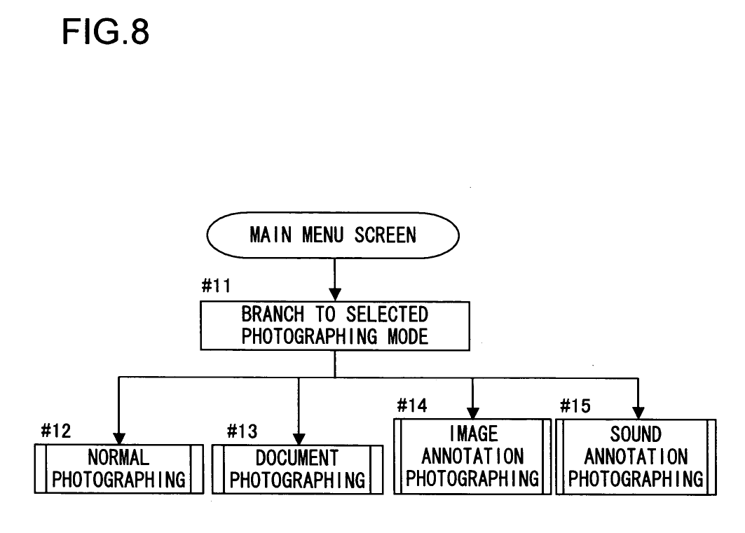

FIG. 8 shows the flow of operations performed to change photographing modes on the main menu. The photographing mode that is being selected at the moment that the set button 18 is operated is established (#11 to #15).

When the normal photographing mode is established in step #3 in FIG. 6 or in step #12 in FIG. 8, photographing operations are performed as performed in a common digital camera so that, when an image is photographed, an image file is created and photographing mode information is recorded in the tag thereof.

When the document photographing mode is established in step #4 in FIG. 6 or in step #13 in FIG. 8, photographing operations are performed as performed in a common digital camera, but no flash is emitted by default irrespective of whether the ambience is bright or dim. When an image is photographed, an image file is created and photographing mode information is recorded in the tag thereof.

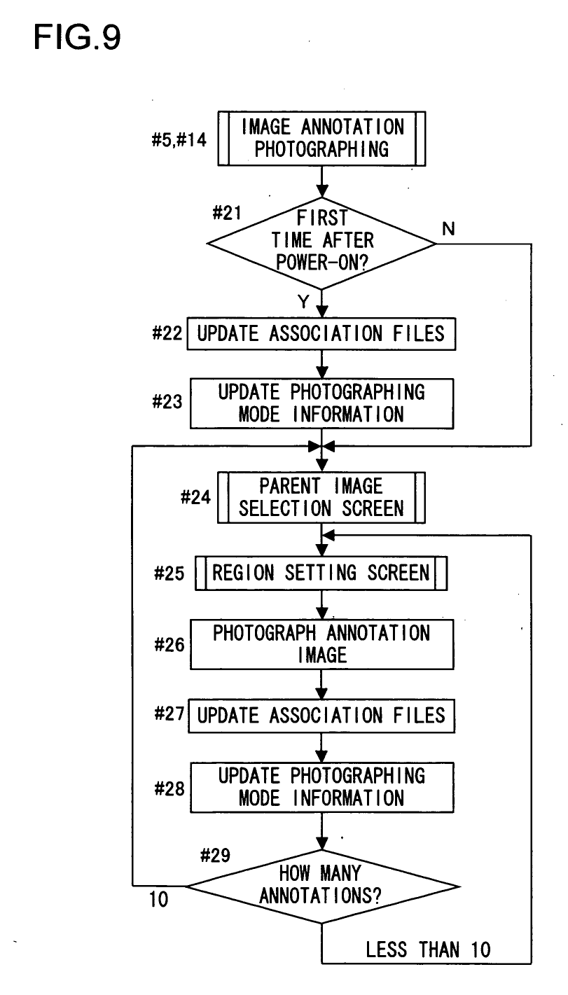

FIG. 9 shows the flow of operations performed when the image annotation photographing mode is established in step #5 in FIG. 6 or in step #14 in FIG. 8. If this mode is established for the first time after the start of the supply of electric power (#21), association files are updated (#22), and photographing mode information is updated (#23). This is to cope with a case where files on the recording medium 6 have been updated by an external device. On completion of the updating, a screen for permitting the selection of a parent image is displayed (#24).

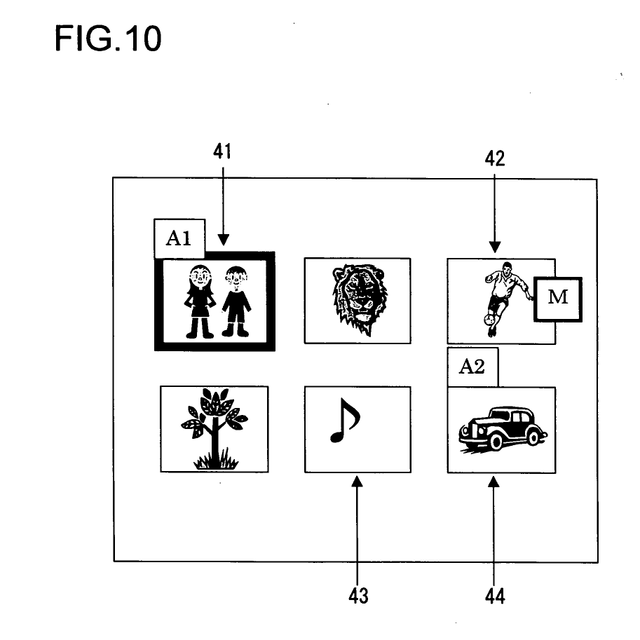

FIG. 10 shows an example of the parent image selection screen. In the parent image selection screen, thumbnail images of the images and sounds recorded in files stored on the recording medium 6 are displayed. Here, since a sound cannot be displayed, for a file in which a sound is recorded, a thumbnail image 43 of a musical note is displayed. The user selects a parent image from among the images so displayed. In the example shown in FIG. 10, the image 41 with a thick border line is selected. A parent image is selected by operating the four direction keys 13, and the selected parent image is confirmed by operating the set button 18.

The symbol “A1” displayed at the border of the thumbnail image 41 indicates that the image of this file has already been used as a parent image in the image annotation photographing mode. The symbol “A2” displayed at the border of the thumbnail image 44 indicates that image of this file has already been used as a parent image in the sound annotation photographing mode. In this way, the attributes of images are displayed on the basis of their photographing mode information to help the user select a parent image. The symbol “M” displayed on the border of the thumbnail image 42 indicates that the image of this file is a moving picture.

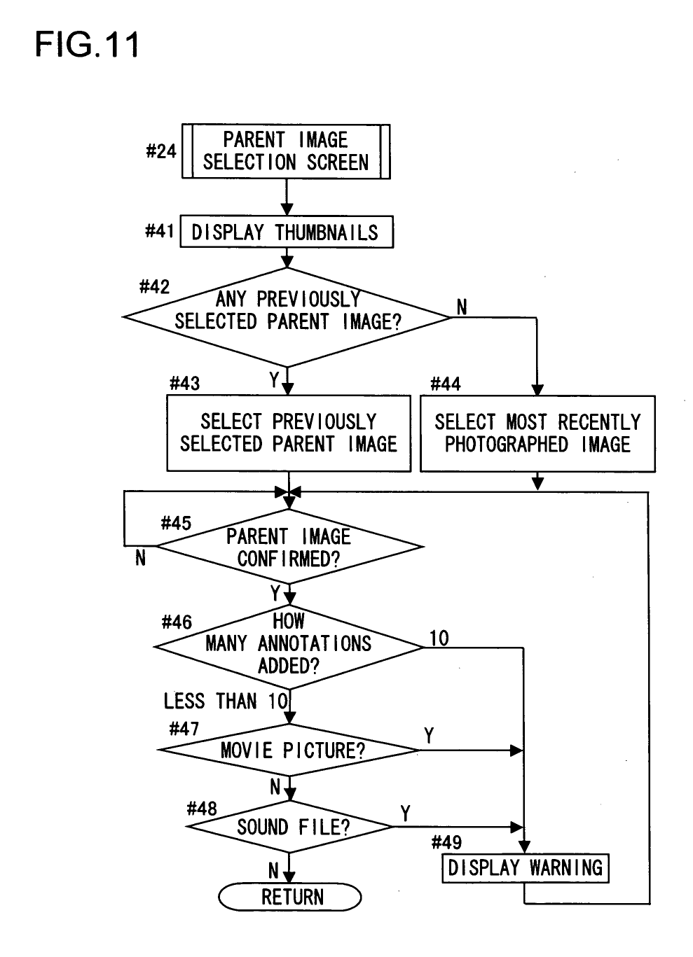

FIG. 11 shows the flow of operations performed to select a parent image. First, thumbnail images are displayed (step #41). If there is any image that has previously been selected as a parent image, that image is brought into a selected state; otherwise, the most recently photographed image is brought into a selected state (#42 to #44). Since the user tends to select as a parent image one that he or she previously has selected as such, bringing into a selected state an image that has previously been used as a parent image helps alleviate the selection operation.

Moreover, to minimize unnecessary consumption of electric power, the digital camera 100 has an automatic power-off capability whereby, when no operation is made in a predetermined period of time, the supply of electric power is automatically stopped. Thus, if the user suspends operation while a parent image is in a selected state, the automatic power-off capability may be executed. Even in such a case, the user can skip the operation for selecting a parent image and proceed with the desired processing. Alternatively, it is also possible to bring the most recently photographed image into a selected state irrespective of whether or not there is any image that has previously been selected as a parent image.

Alternatively, it is also possible to bring into a selected state, instead of an image that has previously been selected as a parent image, an image to which an annotation has already been added. Since the user tends to add another annotation to an image to which an annotation has already been added, doing so helps alleviate the selection operation. In this case, among images to which an annotation has already been added, either the one that has most recently been photographed or the one to which an annotation has most recently been added may be brought into a selected state.

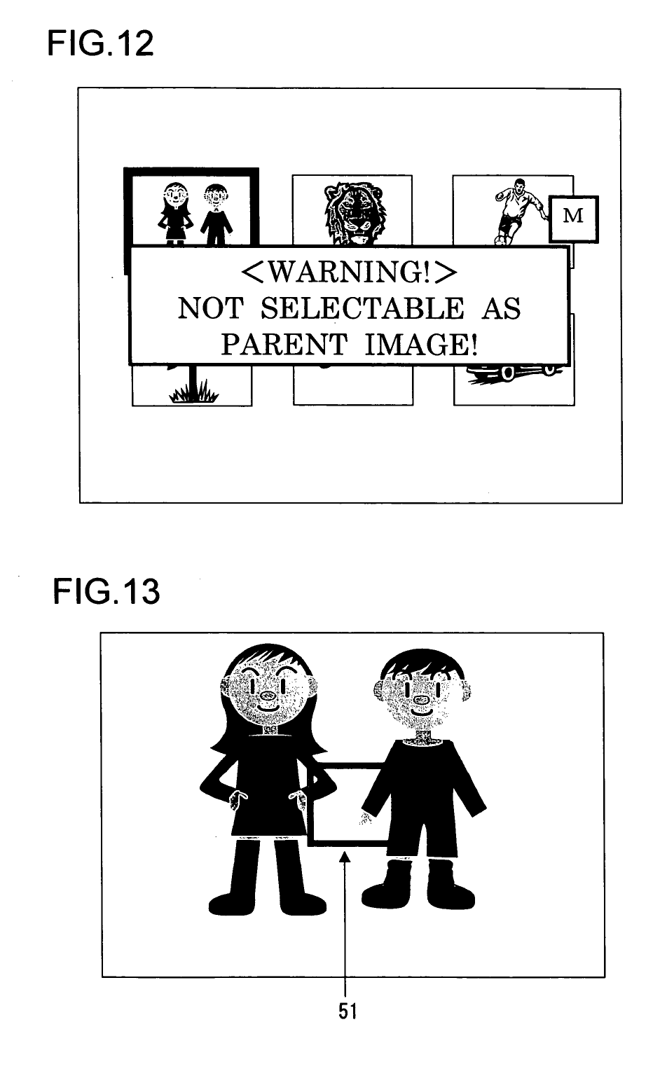

Next, the operation of the direction keys 13 is accepted to permit the selection of an image, and the image that is being selected at the moment that the set button 18 is operated is confirmed as a parent image (#45). Then, whether or not the so confirmed image is usable as a parent image is checked (#46 to #48). Specifically, checks are made here of whether or not the maximum number (in this example, ten) of annotations that can be added to a parent image is exceeded and whether or not a moving picture or a sound is selected. If either of these conditions holds, a warning is displayed as shown in FIG. 12 (#49), and the operation flow returns to step #45. Here, the maximum number of annotations that can be added to a parent image is set at ten. However, in the digital camera 100, in which the association between parent images and annotations are recorded in files, there is inherently no limit to the number of annotations that can be added to a single image, and therefore the maximum number thereof can be set at any number.

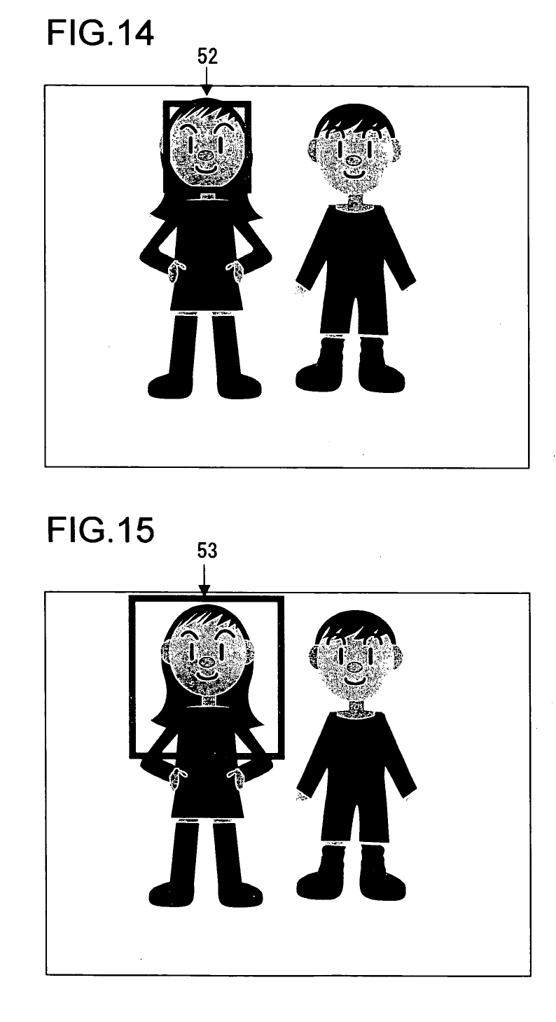

On completion of the selection of a parent image, a region setting screen that permits the setting of the position and size of a region within the parent image to which to add an annotation image is displayed (FIG. 9, step #25). An example of the initial state of this region setting screen is shown in FIG. 13. In the region setting screen, the selected parent image is displayed, and a region frame 51 located at the center of the image is displayed by default. The user moves this region frame 51 to a position where to add an annotation. The region frame can be moved by operating the four direction keys 13. If the user wants to change the size of the region to which to add an annotation, he or she can enlarge or reduce the region frame 51. The region frame can be enlarged or reduced by operating the region size change button 20. An example of the region setting screen including a moved region frame 52 is shown in FIG. 14, and an example the region setting screen including a moved and in addition resized region frame 53 is shown in FIG. 15.

Used as the region in which the region frame 51 is displayed by default in the region setting screen may be the one that was used for focus adjustment when the parent image was photographed. The digital camera 100 adopts servo-based focus adjustment whereby the focus of the taking lens 5 is varied in the direction in which the contrast of the image becomes increasingly high until the focus of the taking lens 5 is set at the position where the contrast is highest. Selectable as the region used for such contrast detection is either the whole image or part of it, and selectable as the part of the image is one among a plurality of regions located at the center and in other parts of the image. By using by default, among those regions, the one that was used for focus adjustment when the parent image was photographed, it is possible to easily add an annotation to the part of an image that was of most interest when the user photographed the image. The region that was used for focus adjustment is recorded in the tag of an image file.

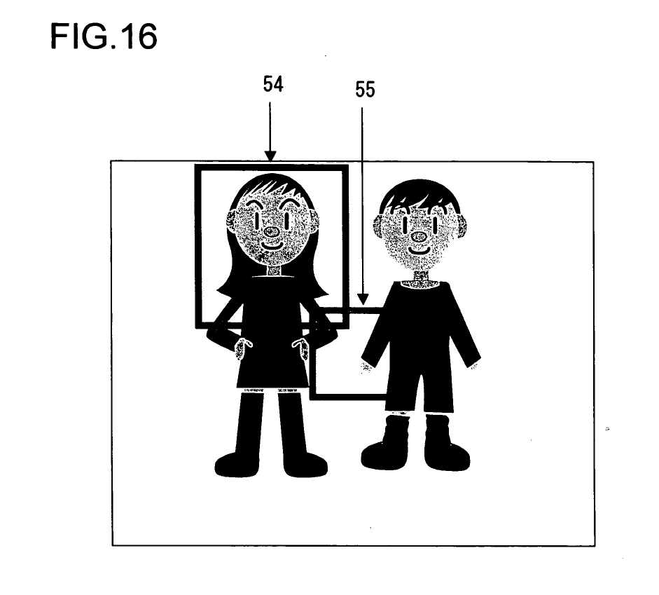

FIG. 16 shows a region selection screen displayed when an annotation has already been added to the selected parent image. The region frame 54 corresponds to the already added annotation, and the region frame 55 is the one displayed by default for a new annotation. The region frames 54 and 55 are displayed in different modes of display, as in different colors, different line types, or different line thicknesses. If a plurality of annotations have already been added, the region frames corresponding to all the annotations are displayed in different modes of display.

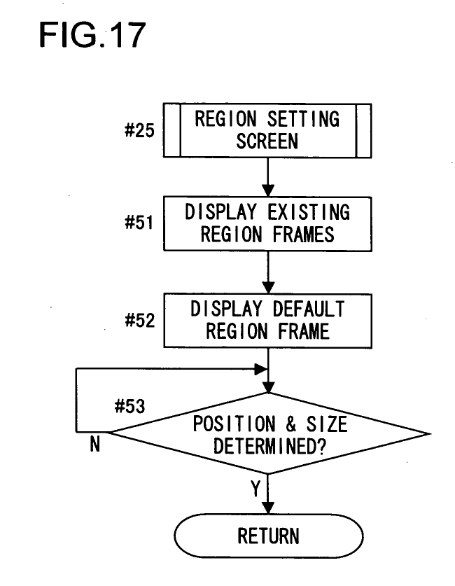

FIG. 17 shows the flow of operations performed to set a region. First, if an annotation already exists, the region frame corresponding thereto is displayed (step #51), and then the default region frame for a newly added annotation is displayed (#52). Then, the user's operation is accepted to adopt the confirmed position and size (#53).

With reference back to FIG. 9, the description of the operations performed in the image annotation photographing mode will be continued. After, in the region setting screen, a region to which to add an annotation is set, an annotation image is photographed (step #26), the association file is updated (#27), and the photographing mode information is updated (#28). Then, whether or not the total number of annotations added to the parent image has reached the maximum (in this example, as described earlier, ten) is checked (#29). If the total number has already reached the maximum, the operation flow returns to step #24 to permit the selection of a new parent image; otherwise, the operation flow returns to step #25 to permit the setting of a region within the currently selected parent image to which to add a new annotation.

If the user wants to select a new parent image when the total number of annotations has not yet reached the maximum, he or she can return from step #25 to #24 by operating the main menu button 15. When the main menu button 15 is operated in step #24, the main menu described earlier is displayed to permit the selection of a photographing mode.

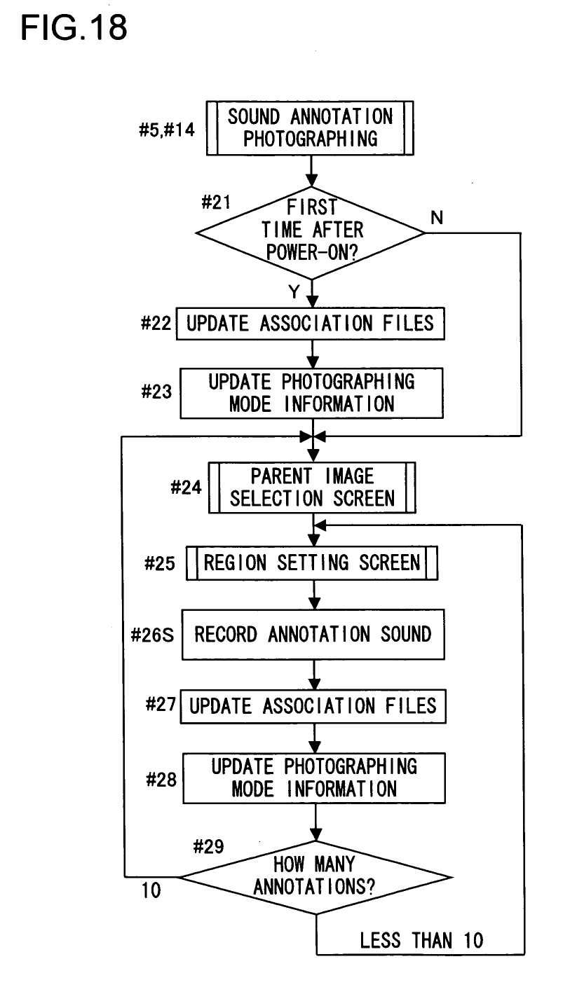

FIG. 18 shows the flow of operations performed when the sound annotation photographing mode is established in step #5 in FIG. 6 or in step #14 in FIG. 8. Here, in place of the step (#26) of photographing an annotation image in FIG. 9, a step (#26S) of recording an annotation sound is inserted.

The updating of an association file and the updating of photographing mode information are performed on the occasions (1) to (4) described below according to the rules described below:
(1) When the photographing of an annotation image or the recording of an annotation sound is completed.
   (a) If no annotation file has already been added to the parent image, an annotation folder and an association file are newly created, and annotation information is written to the association file. Moreover, the photographing mode information of the parent image is updated, and photographing mode information is written to the created annotation image or sound file.
   (b) If any annotation file has already been added to the parent image, annotation information is additionally written to the association file. Moreover, the photographing mode information of the parent image is updated, and photographing mode information is written to the created annotation image or sound file.
(2) When the image annotation photographing mode or the sound annotation photographing mode is established for the first time after the start of the supply of electric power.
   (a) Whether or not the files of the parent image, annotation images, and annotation sounds recorded in the association file stored in a given annotation folder actually exist is checked. If any of them is found to be nonexistent, the corresponding portions of the association file are deleted.
   (b) If none of the files of the annotation images and annotation sounds recorded in the association file exist, the association file and the annotation folder are deleted.
   (c) If the file of the parent image is found to be nonexistent, the corresponding association file and annotation folder (along with the files of the annotation images and annotation sounds recorded therein) are deleted.
   (d) If no association file exists, the annotation folder (along with the files of the annotation images and annotation sounds recorded therein) is deleted.
   (e) In consistency with the operations (a) to (d) done as described above, the photographing mode information of the parent image file, annotation image files, and annotation sound files is updated.
   (f) The operations (a) to (e) described above are performed for every annotation folder.
(3) When a recording medium is mounted while electric power is being supplied. The same operations as described under (2) above are performed.
(4) When an external device is disconnected while electric power is being supplied. The same operations as described under (2) above are performed.

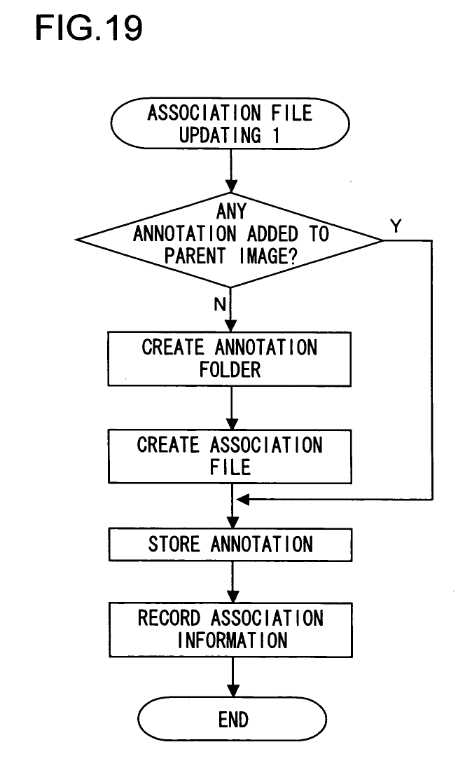

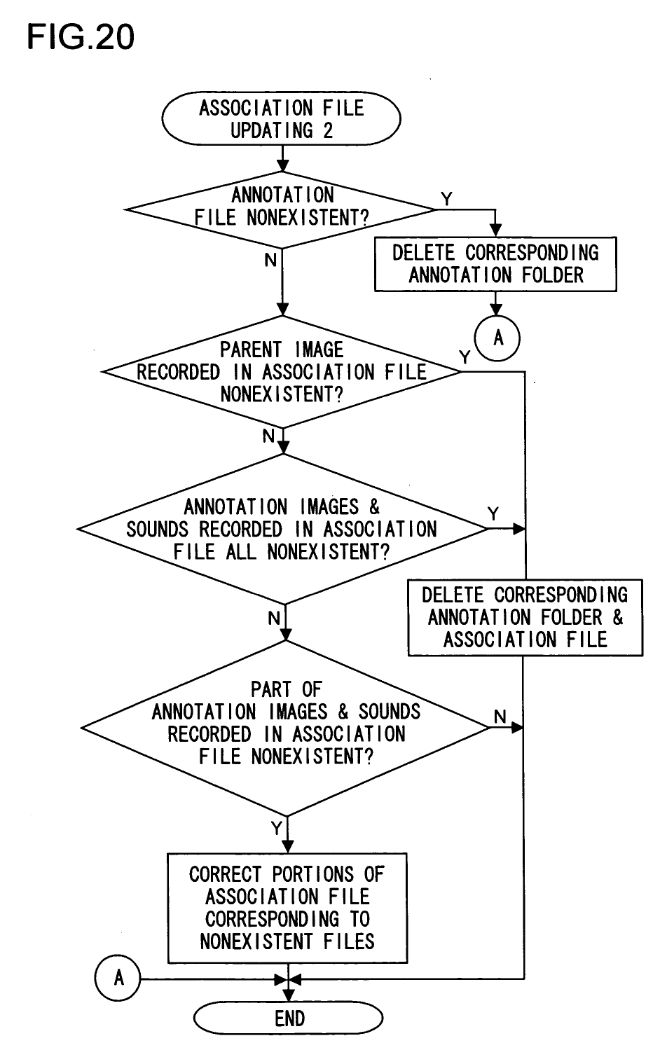

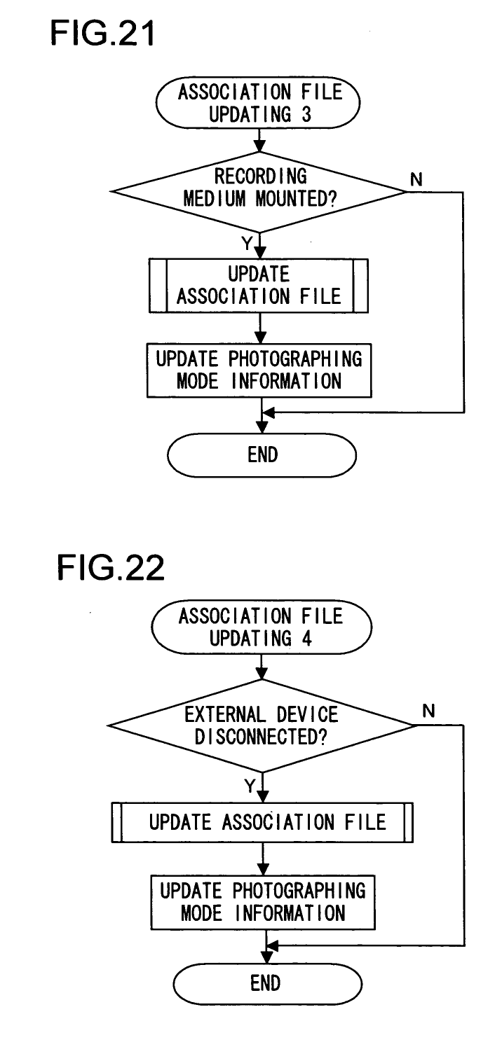

The flow of operations described under (1) above is shown in FIG. 19. The flow of operations described under (2) above is shown in FIG. 20. The flow of operations described under (3) above is shown in FIG. 21. The flow of operations described under (4) above shown in FIG. 22.

An example of the contents of an association file before and after updating and an example of photographing mode information before and after updating are shown in Tables 3 and 4 respectively.

TABLE 3
Association File

| | | |
|---|---|---|
| Item | Content | Value |

(a) Before Updating

| | | |
|---|---|---|
| | Parent Image | |
| 1 | Parent image file name | Pict0001.jpg |
| 2 | Parent image file creation date and time | 2003.05.26 15:21 |
| | Annotation 1 | |
| 3 | Annotation region position information | 100, 200 |
| 4 | Annotation region size information | 160, 160 |
| 5 | Annotation file name | Ann0001.jpg |
| 6 | Annotation file creation date and time | 2003.05.26 15:26 |
| | Annotation 2 | |
| 3 | Annotation region position information | 950, 350 |
| 4 | Annotation region size information | 200, 200 |
| 5 | Annotation file name | Ann0002.jpg |
| 6 | Annotation file creation date and time | 2003.05.26 15:30 |
| | Annotation 3 | |
| 3 | Annotation region position information | 650, 450 |
| 4 | Annotation region size information | 100, 100 |
| 5 | Annotation file name | Ann0003.wav |
| 6 | Annotation file creation date and time | 2003.05.26 15:33 |

(b) After Updating

| | | |
|---|---|---|
| | Parent Image | |
| 1 | Parent image file name | Pict0001.jpg |
| 2 | Parent image file creation date and time | 2003.05.26 15:21 |
| | Annotation 1 | |
| 3 | Annotation region position information | 100, 200 |
| 4 | Annotation region size information | 160, 160 |
| 5 | Annotation file name | Ann0001.jpg |
| 6 | Annotation file creation date and time | 2003.05.26 15:26 |
| | Annotation 2 | |
| 3 | Annotation region position information | 950, 350 |
| 4 | Annotation region size information | 200, 200 |
| 5 | Annotation file name | Ann0002.jpg |
| 6 | Annotation file creation date and time | 2003.05.26 15:30 |

TABLE 4
Photographing Mode Information

| | | |
|---|---|---|
| | Values | |
| File | (Bits 0 to 7) | Meaning of the Values |

(a) Before Updating

| | | |
|---|---|---|
| Pict0001.jpg | 10101000 | Image photographed in the normal photographing mode + Parent |
| | | image in the image annotation photographing mode + Parent |
| | | image in the sound annotation photographing mode |
| Ann0001.jpg | 00010000 | Annotation image photographed in the image annotation |
| | | photographing mode |
| Ann0002.jpg | 00010000 | Annotation image photographed in the image annotation |
| | | photographing mode |
| Ann0003.wav | 00000100 | Annotation sound recorded in the sound annotation |
| | | photographing mode |

(b) After Updating

| | | |
|---|---|---|
| Pict0001.jpg | 10100000 | Image photographed in the normal photographing mode + Parent |
| | | image in the image annotation photographing mode |
| Ann0001.jpg | 00010000 | Annotation image photographed in the image annotation |
| | | photographing mode |
| Ann0002.jpg | 00010000 | Annotation image photographed in the image annotation |
| | | photographing mode |

Tables 3 and 4 show the following case: an image photographed in the normal photographing mode is used as a parent image, then two annotation images are added thereto in the image annotation photographing mode, and then one annotation sound is added thereto in the sound annotation photographing mode, with all the relevant files recorded on the recording medium 6. Thereafter, the file of the annotation sound is deleted from the recording medium 6 by an external device such as a personal computer, and then the same recording medium 6 is mounted again on the digital camera 100. The parent image file is named “Pict0001.jpg.” The two annotation image files are named “Ann0001.jpg” and “Ann0002.jpg.” The annotation sound file is named “Ann0003.wav.”

When the annotation sound file “Ann0003.wav” is deleted, as shown in Table 4(b), in the photographing mode information of the parent image file “Pict0001.jpg,” bit 4 indicating that it is a parent image in the sound annotation photographing mode is cleared.

If not only the file “Ann0003.wav” but also the files “Ann0001.jpg” and “Ann0002.jpg” are deleted, the association file itself is deleted, and in addition, in the photographing mode information of the file “Pict0001.jpg,” bit 2 indicating that it is a parent image in the image annotation photographing mode is cleared. If the file “Pict0001.jpg” is deleted, the association file itself is deleted, and in addition the annotation files “Ann0001.jpg,” “Ann0002.jpg,” and “Ann0003.wav” are deleted.

The digital camera 100 has a quick view capability that permits an image or a sound recorded on the recording medium 6 to be reproduced in a photographing mode. The quick view capability can be used in any of the normal photographing mode, document photographing mode, image annotation photographing mode, and sound annotation photographing mode. A quick view can be started by operating the quick view button 16.

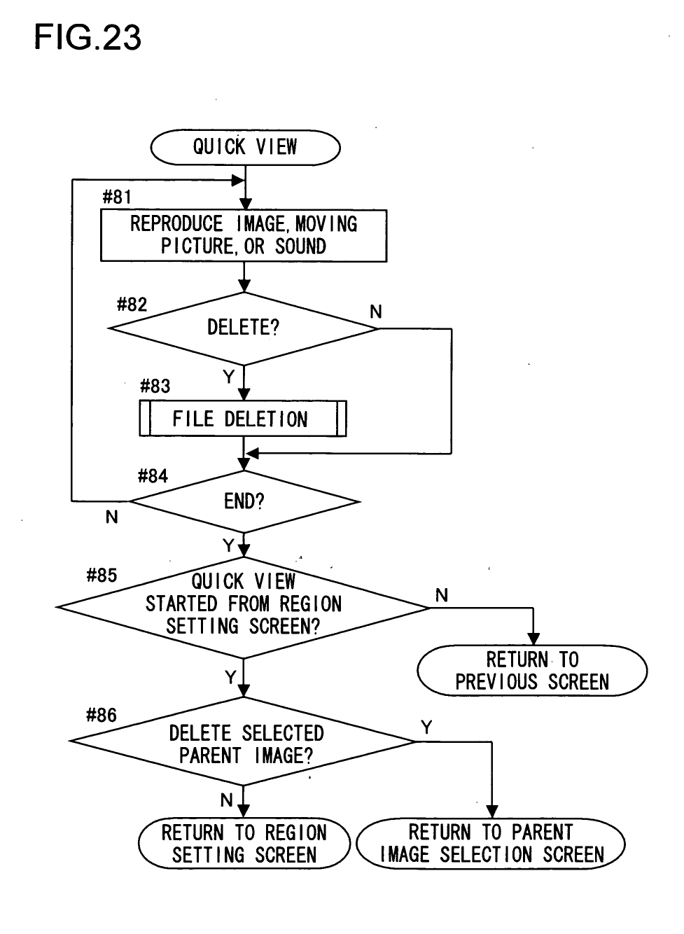

FIG. 23 shows the flow of operations performed to provide a quick view. When the quick view button 16 is operated, the most recently photographed or recorded image, moving picture, or sound is reproduced (step #81). During reproduction, by operating, among the four direction keys 13, the left or right key, it is possible to switch the image or sound being reproduced. During reproduction, when the delete button 17 is operated (#82), the file of the image or sound being reproduced is deleted (#83).

The quick view can be ended (#84) by operating the quick view button 16 again. On completion of a quick view, if the quick view was started from elsewhere than the region setting screen (FIG. 9, step #25), the screen returns to the one that was displayed immediately before the quick view; if the quick view was started from the state in which the region setting screen was displayed, it is checked whether or not the parent image in which a region was going to be set has been deleted (#86), and, if it has not been deleted, the screen returns to the one that was displayed immediately before the quick view, i.e., the region setting screen. By contrast, if the parent image in question has been deleted, there is no longer any sense in keeping that parent image selected, and therefore the screen returns to the parent image selection screen (FIG. 9, step #24).

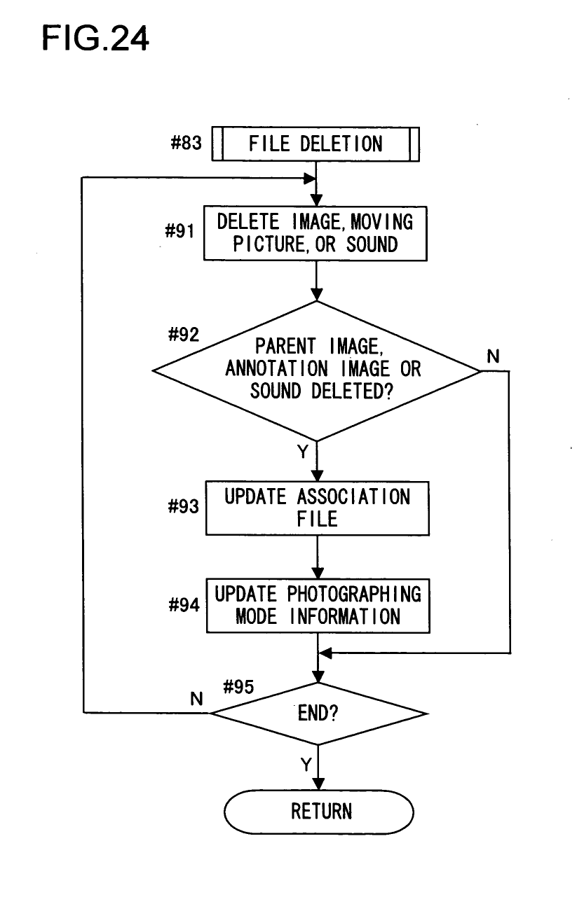

FIG. 24 shows the flow of operations performed to delete a file in step #83. When the delete button 17 is operated, the image, moving picture, or sound that is being reproduced is deleted (step #91). Then, whether or not the deleted file is the file of a parent image, annotation image, or annotation sound is checked (#92), and, if so, the association file and the photographing mode information are updated according to Tables 1 and 2 (#93 and #94).

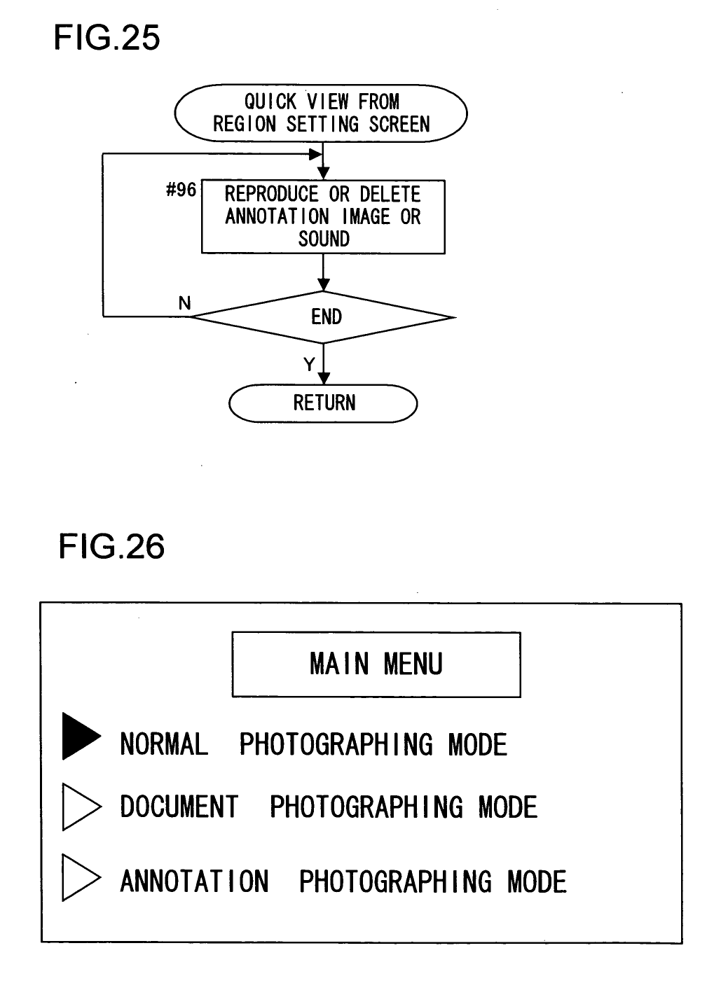

FIG. 25 shows another flow of operations performed to start a quick view from the state in which the region setting screen is displayed. In this operation flow, only annotation images or annotation sounds added to the selected parent image are reproduced (step #96). Deletion of files is also possible only with annotation images or annotation sounds added to the selected parent image. This makes it easy to grasp what annotations are added to the parent image, and reduces the risk of erroneously deleting a file that is unrelated to the parent image.

In the annotation mode of the digital camera 100 described thus far, the image annotation photographing mode and the sound annotation photographing mode run separately, and one of them is selected on the main menu (FIG. 7). This configuration is convenient in cases where a plurality of annotation images are successively added to a parent image or a plurality of annotation sounds are successively added to a parent image. With this configuration, however, adding both an annotation image and an annotation sound to a parent image requires returning to the main menu to change photographing modes, and this is somewhat troublesome.

Moreover, the method described thus far assumes that images to which annotations can be added are limited to those already recorded on the recording medium 6. Accordingly, if the user wants to photograph an image first and then add an annotation to that image, he or she has to set first the normal photographing mode on the main menu, then photograph and record an image, then set the image annotation photographing mode or the sound annotation photographing mode on the main menu, and then photograph an annotation image or record an annotation sound. This also is somewhat troublesome.

Now, a description will be given of a method of efficiently setting a mode in cases where different types of annotation (images and sounds) are successively added or where an annotation is added to an image that is going to be photographed. The main menu used by this method is shown in FIG. 26. Here, instead of the image annotation photographing mode and the sound annotation photographing mode, a single annotation photographing mode is provided, and is displayed in parallel with the normal photographing mode and the document photographing mode.

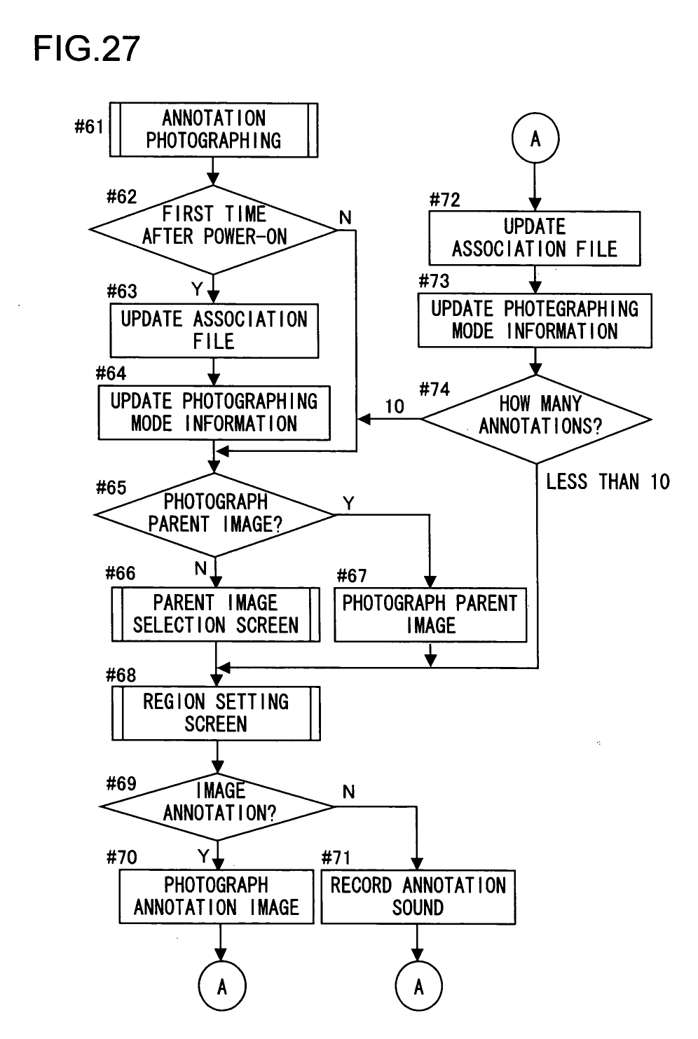

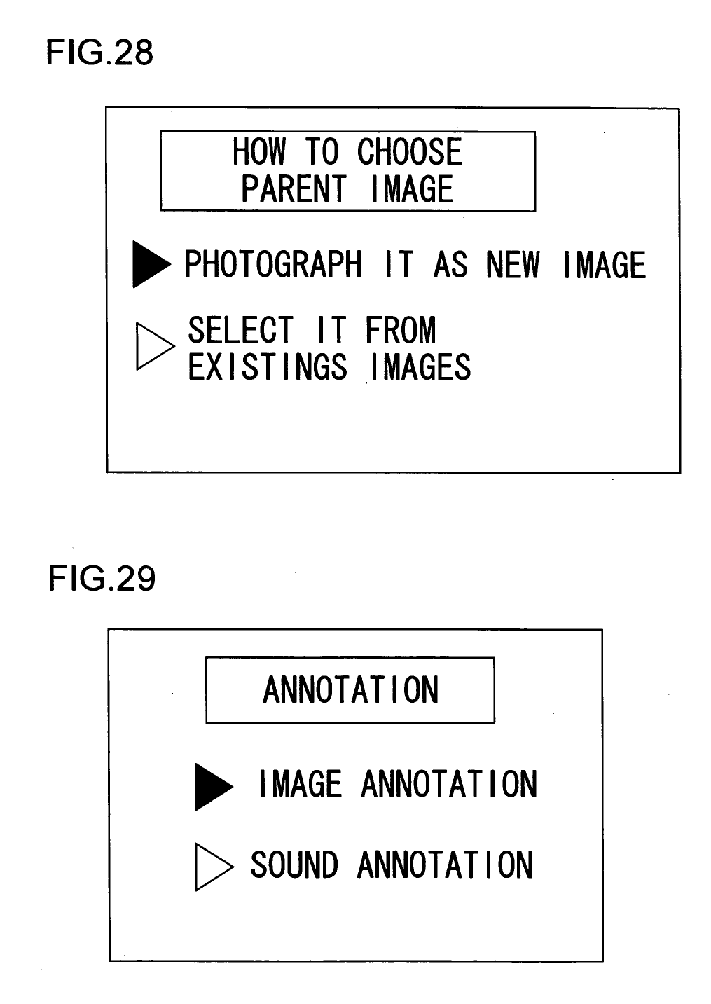

FIG. 27 shows the flow of operations performed in the annotation photographing mode. First, if this mode is established for the first time after the start of the supply of electric power, association files and photographing mode information are updated (steps #62 to #64). The operations performed here are the same as those performed in steps #21 to #23 shown in FIG. 9 described earlier. Next, the screen shown in FIG. 28 is displayed to permit the use to choose whether to use as a parent image one that is going to be photographed or one already recorded on the recording medium 6 (step #65). The user chooses one of the alternatives by operating the direction keys 13, and then confirms the choice by operating the set button 18.

If an image that is going to be photographed is confirmed to be used as a parent image, the operation flow proceeds to step #67; if an image that already exists is confirmed to be used as a parent image, the operation flow proceeds to step #66. In step #66, the sequence of operations shown in FIG. 11 described earlier is performed. In step #67, an image to be used as a parent image is photographed as one is usually photographed.

When a parent image is determined in this way, then, as in step #25 in FIG. 9, the region setting screen is displayed to permit the setting of the position and size of a region to which to add an annotation (#68). When a region is set, the screen shown in FIG. 29 is displayed to permit the user to choose whether to add as an annotation an image or a sound (#69). The user chooses one of the alternatives by operating the direction keys 13, and then confirms the choice by operating the set button 18.

According to the choice the user has made, either an annotation image is photographed (#70) or an annotation sound is recorded (#71). Then, as in steps #27 and #28 in FIG. 9, the association file and the photographing mode information are updated (steps #72 and #73). Then, whether or not the number of annotations added to the parent image has reached the limit value (here, ten) is checked (#74). If the maximum number has been reached, the operation flow returns to step #65 to permit the choice of whether to use as a parent image one that already exists or one that is going to be photographed; if the maximum number has not been reached, the operation flow returns to step #68 to permit the setting of the position and size of a region.

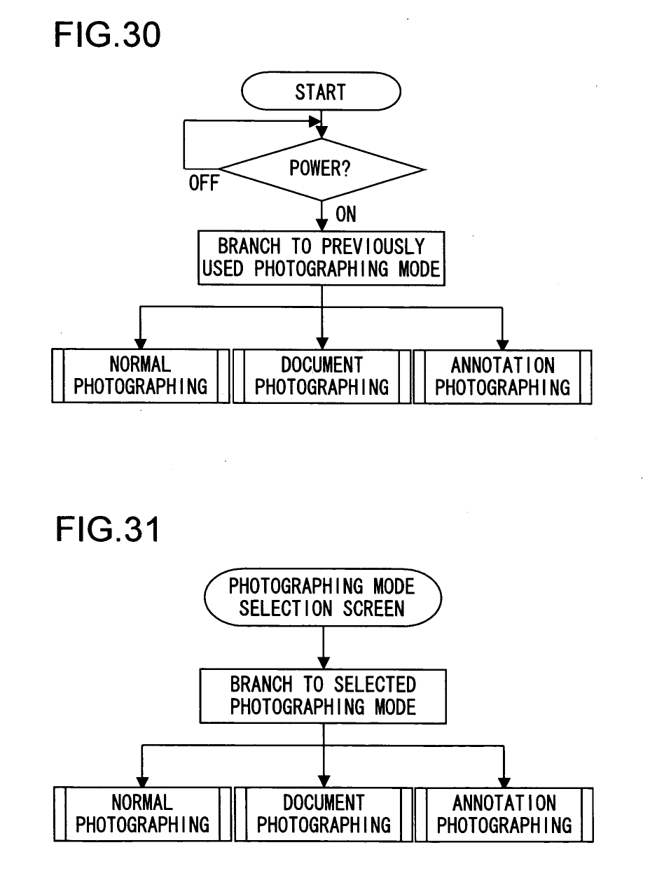

Also in this mode setting method, the photographing mode used at the moment that the supply of electric power is stopped is stored, and the stored photographing mode is restored next time that the supply of electric power is started. FIG. 30 shows the flow of operations performed to set a photographing mode at the start of the supply of electric power. FIG. 31 shows the flow of operations performed to change modes when a photographing mode is selected on the main menu.

By this mode setting method, when the user wants to add an annotation to an image that is going to be photographed, he or she can photograph an image and then immediately add an annotation thereto, thus with increased efficiency. Moreover, when the user wants to add an annotation image and an annotation sound successively to a single parent image, he or she can do that without selecting the parent image again in the course, thus with increased efficiency.

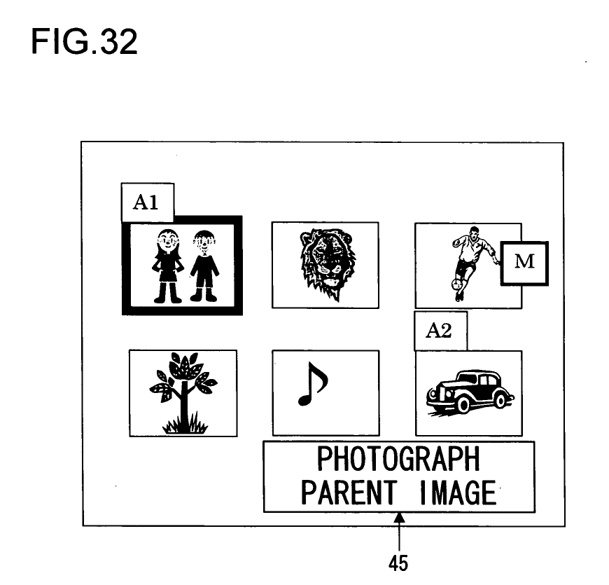

Here, the screen for permitting the choice of whether to use as a parent image one that is going to be photographed or one that has already been recorded on the recording medium 6 and the screen for permitting the selection of an image that already exists on the recording medium 6 are displayed in successive, separate steps (steps #65 and #66 in FIG. 27). It is, however, also possible to display these screens at once. An example of the screen displayed for that purpose is shown in FIG. 32.

In this screen, like the one shown in FIG. 10 described earlier, there are displayed, in an arranged manner, thumbnail images of files stored in the recording medium 6. In addition, here, there is also displayed an image 45 that reads “Photograph Parent Image” to indicate that an image that is going to be photographed will be used as a parent image. By selecting this image 45, the user can choose to use as a parent image an image that is going to be photographed; by selecting one of the thumbnail images other than the image 45, the user can choose to use as a parent image an image that already exists and simultaneously select which existing image to use as a parent image. This helps reduce the number of times the screen needs to be switched, and thus helps achieve more efficient operation.

Obviously, many modifications and variations of the present invention are possible in light of the above teachings. It is therefore to be understood that within the scope of the appended claims, the invention may be practiced other than as specifically described.

1. An image taking apparatus comprising:
an image generator for generating an image;
an annotation generator for generating an annotation that is to be added to a partial region within the image generated by the image generator;
a file generator for generating an association file in which association between the image generated by the image generator and the annotation generated by the annotation generator is recorded; and
a recorder for recording the association file generated by the file generator on a recording medium.

2. An image taking apparatus as claimed in claim 1,
wherein the association file is updated with predetermined timing.

3. An image taking apparatus as claimed in claim 1,
wherein, when at least either the image having the annotation added thereto or the annotation is deleted, the association file is updated.

4. An image taking apparatus as claimed in claim 1,
wherein, when a mode for adding an annotation is established for a first time after starting of supply of electric power, the association file is updated.

5. An image taking apparatus as claimed in claim 1,
wherein, when a mode for adding an annotation is established for a first time after starting of supply of electric power, if at least either the image having the annotation added thereto or the annotation does not exist, the association file is updated.

6. An image taking apparatus as claimed in claim 1,
wherein, when the recording medium is mounted, the association file is updated.

7. An image taking apparatus as claimed in claim 1,
wherein, when the recording medium is mounted, if at least either the image having the annotation added thereto or the annotation does not exist, the association file is updated.

8. An image taking apparatus as claimed in claim 1,
wherein, when an external device is disconnected, the association file is updated.

9. An image taking apparatus as claimed in claim 1,
wherein, when an external device is disconnected, if at least either the image having the annotation added thereto or the annotation does not exist, the association file is updated.

10. An image taking apparatus as claimed in claim 1,
wherein the image to which the annotation is added, the annotation itself, and the association file in which the association between the image and the annotation is recorded are recorded, in a form stored in a single folder, on the recording medium.

11. An image taking apparatus as claimed in claim 1,
wherein in the association file is recorded
information relating to an image file in which the image having the annotation added thereto is recorded and
information relating to an annotation file in which the annotation is recorded.

12. An image taking apparatus as claimed in claim 1,
wherein in the association file is recorded information relating to the partial region within the image to which the annotation is added.

13. An image taking apparatus as claimed in claim 1, further comprising:
a display for displaying the image and the annotation according to a content of the association file.

14. An image taking apparatus as claimed in claim 1,
wherein the annotation is in a form of at least either an image or a sound.

15. A method of adding an annotation to a partial region within an image, comprising the steps of:
generating an annotation;
generating an association file in which association between the image and the annotation is recorded; and
recording the generated association file on a recording medium.
